(19) United States
(12) Patent Application Publication
(10) Pub. No.: US 2012/0312268 A1
(43) Pub. Date: Dec. 13, 2012

(54) IGNITION COMPONENT

(75) Inventors: Wataru SHIONOYA, Nagoya-City (JP); Kenjiro Shimoda, Nagoya-City (JP); Ryuta Kouno, Nagoya-City (JP); Katsunori Tanaka, Nagoya-City (JP); Takashi Egami, Nagoya-City (JP)

(73) Assignee: NGK Insulators, Ltd., Nagoya-City (JP)

(21) Appl. No.: 13/450,929

(22) Filed: Apr. 19, 2012

(30) Foreign Application Priority Data
Jun. 8, 2011 (JP) 2011-128348

(51) Int. Cl. H01T 13/00; F02B 5/00

(52) U.S. Cl. 123/169 P

(57) ABSTRACT

An ignition component 100 provided with a center electrode 30 and an insulator 32, in which the insulator 32 is formed of a large-diameter portion 33 and a small-diameter portion 34, the large-diameter portion 33 of the insulator 32 is inserted into the plug insertion hole 21 of the cylinder head 20 of the internal combustion engine, and a stepped portion 35 between the large-diameter portion 33 and the small-diameter portion 34 of the insulator 32 is pressed onto and fixed to the side of the cylinder head 20 of the internal combustion engine so that the insulator 32 is attached to the cylinder head 20 of the internal combustion engine is provided.

### BACKGROUND OF THE INVENTION

1. Field of the Invention

The present invention relates to an ignition component. More particularly, the present invention relates to an ignition component for an internal combustion engine in which insulation breakdown of an insulator covering a center electrode can hardly occur.

2. Related Background of the Invention

As an ignition component for igniting fuel or a mixture gas containing fuel in an internal combustion engine such as an engine, a spark plug for an internal combustion engine (hereinafter also referred simply as a “spark plug”) has been used. This spark, plug for an internal combustion engine is mounted on a cylinder head of the internal combustion engine or the like and makes a trigger for start of a combustion cycle by applying high-voltage electricity to a tip thereof and causing ignition by electric discharge.

As a spark plug for an internal combustion engine, a spark plug provided with a center electrode, an insulator disposed on an outer periphery of this center electrode, and a metal housing caulked and fixed to the outer periphery of the insulator, for example, was proposed (See Patent Documents 1 to 3, for example).

In such a spark plug, amounting screw portion to be attached to the cylinder head of the internal combustion engine is formed on an outer peripheral surface of the metal housing. Such a spark plug is attached by being screwed in and fixed to the cylinder head of the internal combustion engine by using the mounting screw portion.

### Patent Document

[Patent Document 1] JP-A-2007-059077

[Patent Document 2] JP-A-2007-073224

[Patent Document 3] JP-A-2007-317448

### SUMMARY OF THE INVENTION

### Problems to be Solved by the Invention

With the trend of size reduction of the engine and diversification of auxiliary machines, a space on which a spark plug is installed is getting smaller. For example, an installation space for a spark plug in a cylinder head of an engine in a general automobile is the size of M14 to 12 (approximately 9.8 to 11.8 mm as an effective diameter) as a reference dimension of a mounting screw portion. Thus, a thickness of an insulator disposed on an outer periphery of a center electrode cannot be sufficiently ensured, and there is a problem that, if a high voltage is applied to the center electrode, insulation breakdown occurs in the insulator.

Moreover, diameter reduction of the space where the spark plug is installed is considered to progress in the future, and furthermore, the problem caused by the insulation breakdown is expected to become marked. Particularly in the prior-art spark plugs, a metal housing is further disposed on the outside of the insulator in order to forma screw portion to be attached to the cylinder head of the internal combustion engine. Thus, in the prior-art spark plug, the thickness of the insulator is further reduced by the thickness of the metal housing.

The present invention has been made in view of the above-described problems and provides an ignition component in which insulation breakdown of an insulator covering a center electrode hardly occurs.

### Means for Solving the Problems

The inventors reviewed an attachment method by screwing a screw portion in a metal housing in a prior-art ignition component (a spark plug, for example) in order to solve the above-described problems of the prior-art technology and completed the present invention. Specifically, the entire outer periphery of the ignition component is formed by an insulator without using the metal housing, and this insulator is formed having a shape to be inserted in a non-screwed state into a plug insertion hole of a cylinder head of an internal combustion engine. The inventor has conceived that the Problem could be solved by configuring as above and completed the present invention. The following ignition component is provided by the present invention.

[1] An ignition component provided with a center electrode and an insulator disposed on an outer periphery of the center electrode, in which the insulator is formed of a columnar body with different diameters having a large-diameter portion which becomes an insertion portion to be inserted into a plug insertion hole of a cylinder head of an internal combustion engine in a non-screwed state and a small-diameter portion having an outer diameter smaller than that of the large-diameter portion and the ignition component is attached to the cylinder head of the internal combustion engine when the large-diameter portion of the insulator is inserted into the plug insertion hole of the cylinder head of the internal combustion engine and a stepped portion between the large-diameter portion and the small-diameter portion of the insulator is pressed onto and fixed to the side of the cylinder head of the internal combustion engine (hereinafter also referred to as a “first invention”).

[2] The ignition component described in [1], further provided with insulator fixing means for pressing the stepped portion of the insulator onto the side of the cylinder head .of the internal combustion engine.

[3] The ignition component described in [2], in which the insulator fixing means is a washer-shaped pressing member in which an insulator through hole larger than the outer diameter of the small-diameter portion and smaller than the outer diameter of the large-diameter portion is formed.

[4] An ignition component provided with a center electrode and an insulator disposed on an outer periphery of the center electrode, in which the insulator has a columnar insulator main body inserted into a plug. insertion hole of a cylinder head of an internal combustion engine in a non-screwed state and a flange portion in which a part of a side face of the insulator main body protrudes so that the outer diameter thereof becomes larger than the outer diameter of the insulator main body, and the ignition component is attached to the cylinder head of the internal combustion engine when the insulator main body of the insulator is inserted into an opening portion of the plug insertion hole of the cylinder head of the internal combustion engine so that the flange portion of the insulator is brought into contact with a peripheral edge of the opening portion of the plug insertion hole and the flange portion in contact with the peripheral edge of the opening portion of the plug insertion hole and the cylinder head of the internal combustion engine are fixed (hereinafter also referred to as a “second invention”).

[5] The ignition component described in [4], in which a length of the flange portion in a direction to be inserted into the plug insertion hole is 5 mm or more.

[6] The ignition component described in [4] or [5], in which the length of the Flange portion in the direction to be inserted into the lug insertion hole gradually decreases from a root portion to the outermost periphery portion of the flange portion, and a portion from the root portion to the outermost periphery portion of the flange portion is formed in the tapered shape with respect to a surface perpendicular to the direction inserted into the plug insertion hole.

[7] The ignition component described in any of [4] to [6], further provided with insulator fixing means for fixing the flange portion in contact with the peripheral edge of the opening portion of the plug insertion hole and the cylinder head of the internal combustion engine.

[8] The ignition component described in [7] , in which the insulator fixing means is a pressing member for pressing and supporting the flange portion in contact with the peripheral edge of the opening portion of the plug insertion hole onto the side of the cylinder head of the internal combustion engine.

[9] The ignition component described in [3] or [8], in which in the pressing member, a fastening through hole into which a fastening member for fastening the pressing member and the cylinder head for the internal combustion engine is inserted is further formed, the fastening member is inserted through the fastening through hole of the pressing member, and the pressing member and the cylinder head of the internal combustion engine are fixed by fastening.

[10] The ignition component described in [9], in which the fastening member has a head portion having a diameter larger than the through hole and a screw portion extended from the head portion and capable of being screwed into a screw hole formed on a peripheral edge of the opening portion of the plug insertion hole of the cylinder head of the internal combustion engine.

[11] The ignition component described in any of [1] to [10], in which a thickness of a portion of the insulator to be inserted into the plug insertion hole is 2 mm or more.

[12] The ignition component described in any of [1] or [11], in which a tapered sealed portion is formed at the tip portion of the insulator to be inserted into the plug insertion hole.

### Advantages of the Invention

The ignition component of the present invention is configured such that an insulator disposed on an outer periphery of a center electrode is inserted into a plug insertion hole of a cylinder head of an internal combustion engine in a non-screwed state. That is, the ignition component of the present invention is not provided with a metal housing on which a screw portion to be attached to the cylinder head of the internal combustion engine is formed as in a prior-art ignition component. The ignition component of the invention is configured so as to be attached in a state in which the columnar insulator is directly inserted into the plug insertion hole of the cylinder head of the internal combustion engine.

Particularly, the ignition component of the first invention is provided with a center electrode and an insulator disposed on an outer periphery of the center electrode. The insulator of the ignition component of the first invention is formed of a columnar body with different diameters having a large-diameter portion which becomes an insertion portion to be inserted into a plug insertion hole of a cylinder head of an internal combustion engine in a non-screwed state and a small-diameter portion having an outer diameter smaller than that of the large-diameter portion. The ignition component of the second invention is provided with a center electrode and an insulator disposed on an outer periphery of the center electrode. The insulator of the ignition component of the second invention has a columnar insulator main body to be inserted into the plug insertion hole of the cylinder head of the internal combustion engine in a non-screwed state and a flange portion in which a part of a side face of the insulator main body protrudes so that the outer diameter thereof becomes larger than the outer diameter of the insulator main body.

According to the ignition component of the present invention configured as above (that is, the first invention and the second invention), insulation breakdown of the insulator covering the center electrode can be made difficult to occur. That is, the ignition component of the present invention can increase the thickness of the insulator by a portion corresponding to the thickness of a metal housing as compared with a prior-art ignition component. Thus, withstand voltage of the insulator can be favorably improved without changing the size of the ignition component itself, or in other words, the size of a space where the ignition component is to be installed from the size of the prior-art ignition component, whereby insulation breakdown of the insulator can be made difficult to occur.

The insulator used in the ignition component of the present invention has a portion to be inserted into the plug insertion hole of the cylinder head of the internal combustion engine in a non-screwed state formed having a columnar (cylindrical, for example) shape. Thus, in the ignition component of the present invention, electrical field strength between the insulator and the plug insertion hole is made uniform. Therefore, insulation breakdown of the insulator can be made more difficult to occur. For example, in the ignition component in which a screw portion is formed on the side face (that is, an outer peripheral face) of the insulator to be screwed in and attached to the plug insertion hole of the cylinder head of the internal combustion engine, suppression of occurrence of the insulation breakdown is extremely difficult as follows. That is, in such an ignition component, a difference occurs in the electrical field intensity between a peak portion and a trough portion of a thread in the screw portion when a high voltage is applied to the center electrode of the ignition component. Thus, even if the thickness of the insulator is increased, suppression of occurrence of insulation breakdown is extremely difficult.

### BRIEF DESCRIPTION OF THE DRAWINGS

FIG. 1 is a perspective view schematically illustrating an embodiment of an ignition component of the present invention (first invention).

FIG. 2 is a sectional view schematically illustrating a section in parallel with a direction in which a center electrode extends in an embodiment of the ignition component of the present invention (first invention).

FIG. 3 is a sectional view schematically illustrating a section in parallel with a direction in which the center electrode extends in a state in which the ignition component in an embodiment of the present invention (first invention) is attached to an internal combustion engine.

FIG. 4 is a sectional view schematically illustrating a section in parallel with a direction in which the center electrode extends in a state in which the ignition component in another embodiment of the present invention (first invention) is attached to the internal combustion engine.

FIG. 5 is a perspective view schematically illustrating an embodiment of an ignition component of the present invention (second invention).

FIG. 6 is a sectional view schematically illustrating a section in parallel with a direction in which a center electrode extends in an embodiment of the ignition component of the present invention (second invention).

FIG. 7 is a sectional view schematically illustrating a section in parallel with a direction in which the center electrode extends in a state in which the ignition component in an embodiment of the present invention (second invention) is attached to an internal combustion engine.

FIG. 8 is a sectional view schematically illustrating a section in parallel with a direction in which the center electrode extends in a state in which the ignition component in another embodiment of the present invention (second invention) is attached to an internal combustion engine.

FIG. 9 is a schematic diagram illustrating a 2D axisymmetric model used in calculation of a static electric field of the ignition component of Example 1.

FIG. 10 is a schematic diagram illustrating the 2D axisymmetric model used in calculation of the static electric field of the ignition component of Comparative Example 1.

FIG. 11 is graph illustrating a result of calculation of the static electric field of the ignition component of Example 1.

FIG. 12 is a graph illustrating a result of calculation of the static electric field of the ignition components of Comparative Examples 1 and 2.

### DESCRIPTION OF THE PREFERRED EMBODIMENTS

Subsequently, an embodiment for putting the present invention into practice will be described in detail by referring to the attached drawings. The present invention is not limited by the following embodiments but should be understood that appropriate changes, improvements and the like of design can be made on the basis of ordinary knowledge of those skilled in the art within a range not departing from the gist of the present invention.

(1) Ignition Component (First Invention):

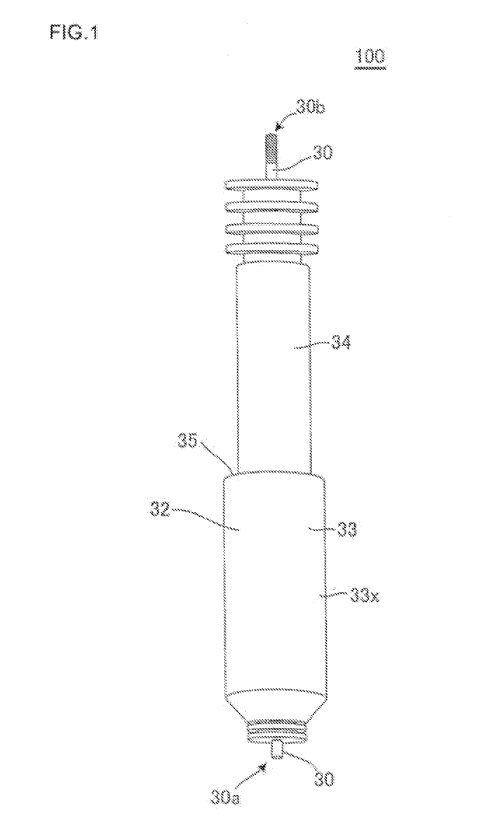

An ignition component 100 of an embodiment of the ignition component of the present invention (first invention) includes, as illustrated in FIGS. 1 to 3, a center electrode 30 and an insulator 32 disposed on an outer periphery of the center electrode 30. In the ignition component 100 of this embodiment, the insulator 32 is formed of a columnar body having different diameters having a large-diameter portion 32 which becomes an insertion portion to be inserted into a plug insertion hole 21 of a cylinder head 20 of an internal combustion engine in a non-screwed state and a small-diameter portion 34 having an outer diameter smaller than this large-diameter portion 33.

The ignition component 100 of this embodiment is attached to the cylinder head 20 of the internal combustion engine in the following state. That is, the large-diameter portion 33 of the insulator 32 is inserted into the plug insertion hole 21 of the cylinder head 20 of the internal combustion engine, and a stepped portion 35 between the large-diameter portion 33 and the small-diameter portion 34 of the insulator 32 is pressed onto and fixed to the side of the cylinder head 20 of the internal combustion engine.

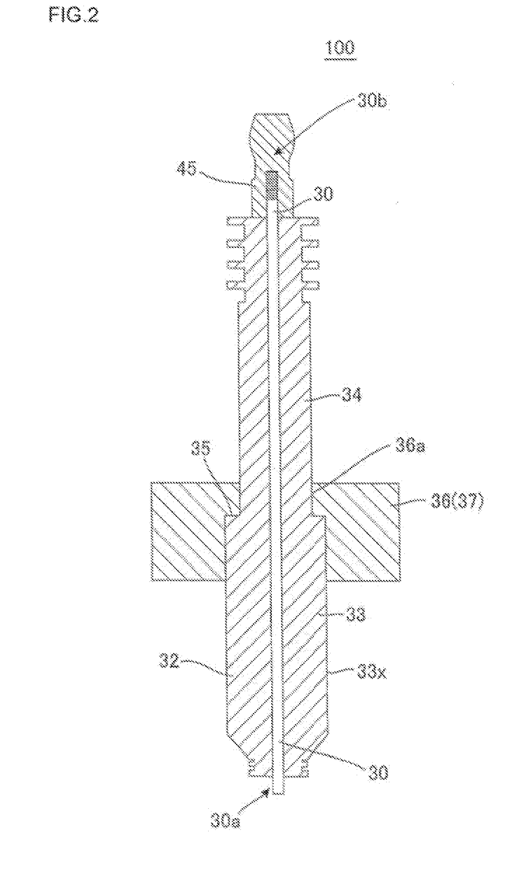

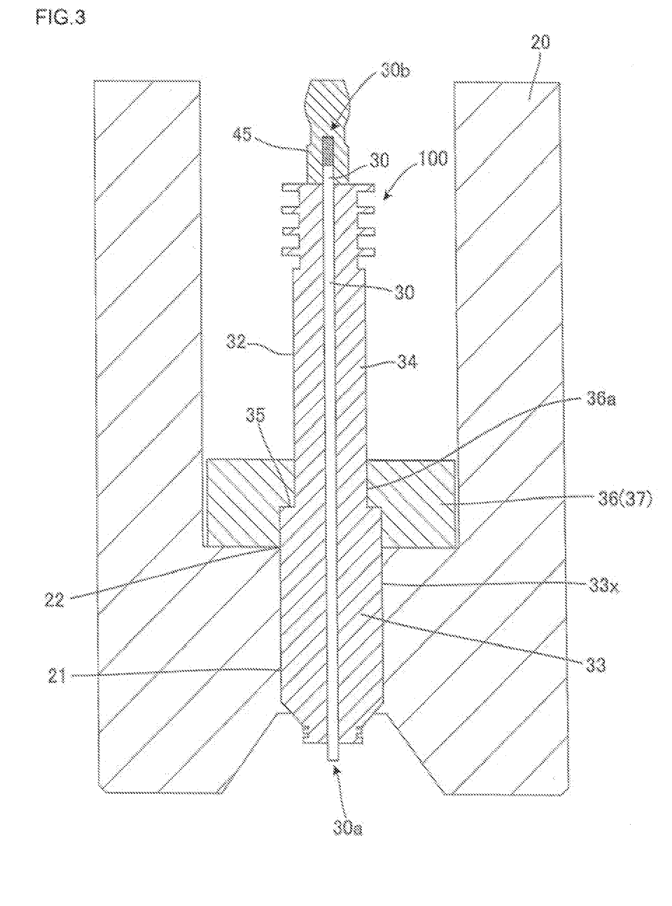

Here, FIG. 1 is a perspective view schematically illustrating an embodiment of the ignition component of the present invention (first invention) . FIG. 2 is a sectional view schematically illustrating a section in parallel with a direction in which the center electrode extends in an embodiment of the ignition component of the present invention (first invention). FIG. 3 is a sectional view schematically illustrating a section in parallel with a direction in which the center electrode extends in a state in which the ignition component is attached to an internal combustion engine in an embodiment of the ignition component of the present invention (first invention). The cylinder head 20 of the internal combustion engine, the plug insertion hole 21, and an opening portion 22 of the plug insertion hole 21 are not constituent elements of the ignition component 100 of this embodiment. That is, the cylinder head 20 of the internal combustion engine and the like are a part of an internal combustion engine using the ignition component 100 of this embodiment. FIG. 2 illustrates an example of the ignition component 100 further provided with insulator fixing means 36.

The ignition component 100 of this embodiment is not provided with a metal housing to be attached to the cylinder head of the internal combustion engine as in a prior-art ignition component. That is, the ignition component 100 of this embodiment is attached by directly inserting the large-diameter portion 33 of the insulator 32 into the opening portion 22 of the plug insertion hole 21 of the cylinder head 20 of the internal combustion engine.

Moreover, a screw portion such as a thread is not formed on a side face 33x of the large-diameter portion 33 of the ignition component 100 of this embodiment. Thus, the ignition component is not attached to the cylinder head by screwing of a screw portion on the metal housing as in the prior-art ignition component. It is needless to say that the screw portion such. as a thread does not have to be formed on the inner peripheral surface of the plug insertion hole 21 of the cylinder head 20 of the internal combustion engine, either. The ignition. component 100 of this embodiment is attached to the cylinder head 20 of the internal combustion engine by inserting the large-diameter portion 33 of the insulator 32 into the opening. portion 22 of the plug insertion hole 21 of the cylinder head 20 of the internal combustion engine in a non-screwed state. The phrase “inserted in the non-screwed state” refers to the state in which an article to be inserted (specifically, the “insulator”) is inserted in parallel with the insertion direction without rotation in screwed insertion performed by a screw or the like. The “insertion direction” refers to a direction in which the ignition component 100 is inserted into the opening portion 22 of the plug insertion hole 21 when the ignition component 100 is to be attached to the cylinder head of the internal combustion engine. Therefore, in the ignition component 100 having a columnar shape elongated in one direction, a direction from one of end portions of the columnar shape (a tip, for example) to the other end portion (an edge, for example) is the insertion direction.

According to the ignition component 100 of this embodiment configured as above, insulation breakdown of the insulator 32 covering the center electrode 30 can be made difficult to occur. That is, in the ignition component 100 of this embodiment, a thickness of the insulator 32 can be increased only by a portion corresponding to the thickness of the metal housing as compared with the prior-art ignition component. Thus, withstand voltage of the insulator 32 can be favorably improved without changing the size of the ignition component 100 itself, or in other words, the size of a space where the ignition component 100 is to be installed from the size of the prior-art ignition component. As a result, insulation breakdown of the insulator 32 can be made difficult to occur. As the size of a space where the ignition component 100 is installed, the inner diameter of the opening portion 22 of the plug insertion hole 21, for example, can be cited.

Moreover, as described above, since a screw portion such as a thread is not formed on the side face 33x of the large-diameter portion 33, electric field intensity between the insulator 32 (or more specifically, the “large-diameter portion 33 of the insulator 32”) and the plug insertion hole 21 is made uniform. That is, the ignition component 100 is attached to the cylinder head 20 of the internal combustion engine in a state in which the side face 33x of the large-diameter portion 33 on which a screw portion such as a thread is not formed and the inner peripheral surface of the plug insertion hole 21 on which a screw portion is not formed, either, are brought into contact with each other or have a slight gap between them. Therefore, insulation breakdown of the insulator 32 can be made difficult to occur. For example, in the ignition component having a screw portion formed on the side face (specifically, the side face of the large-diameter portion) of the insulator and screwed and inserted into the plug insertion hole of the cylinder head of the internal combustion engine, suppression of occurrence of insulation breakdown is extremely difficult as follows. That is, in such an ignition component, when a high voltage is applied to the center electrode of the ignition component, a difference occurs in the electric field intensity between the peak portion and the trough portion of the thread of the screw portion, and even if the thickness of the insulator is increased, suppression of occurrence of insulation breakdown is extremely difficult.

Moreover, in the ignition component 100 of this embodiment, the insulator 32 is formed of a columnar body with different diameters having the large-diameter portion 33 and the small-diameter portion 34, and the stepped portion 35 between the large-diameter portion 33 and the small-diameter portion 34 of the insulator 32 is pressed onto and fixed to the side of the cylinder head 20 of the internal combustion engine. As a result, the ignition component 100 is easily attached to the cylinder head 20 of the internal combustion engine. Moreover, as described above, breakage or the like hardly occurs in the insulator 32 formed of an insulator such as ceramic as long as it is a fixing method of pressing the stepped portion 35 of the insulator 32 onto the side of the cylinder head 20 of the internal combustion engine. A fixing method between the ignition component 100 inserted into the plug insertion hole 21 and the cylinder head 20 of the internal combustion engine is not particularly limited as long as it is the method capable of pressing and fixing the stepped portion 35 of the insulator 32 onto the side of the cylinder head 20 of the internal combustion engine.

The ignition component 100 of this embodiment may be further provided with insulator fixing means 36 for pressing the stepped portion 35 of the insulator 32 onto the side of the cylinder head 20 of the internal combustion engine. For example, in FIG. 3, an example of the ignition component 100 further provided with the above-described insulator fixing means 36 is illustrated. FIG. 3 illustrates an example in which the insulator fixing means 36 is a washer-shaped pressing member 37 in which an insulator through hole 36a larger than the outer diameter of the small-diameter portion 34 and smaller than the outer diameter of the large-diameter portion 33 of the insulator 32 is formed. As the pressing member 37, a fixing bracket (fixing jig) or the like for pressing and supporting the stepped portion 35 of the insulator 32 in the insertion direction of the ignition component 100 can be cited. According to such pressing member 37, the insulator 32 and the cylinder head 20 of the internal combustion engine can be fixed above the opening portion 22 of the plug insertion hole 21. With such a fixing method, the outer shape or thickness of the large-diameter portion 33 of the insulator 32 is not restricted by the fixing method. Thus, high withstand voltage of the insulator 32 can be favorably maintained. Moreover, the stepped portion 35 between the large-diameter portion 33 and the small-diameter portion 34 is hardly broken.

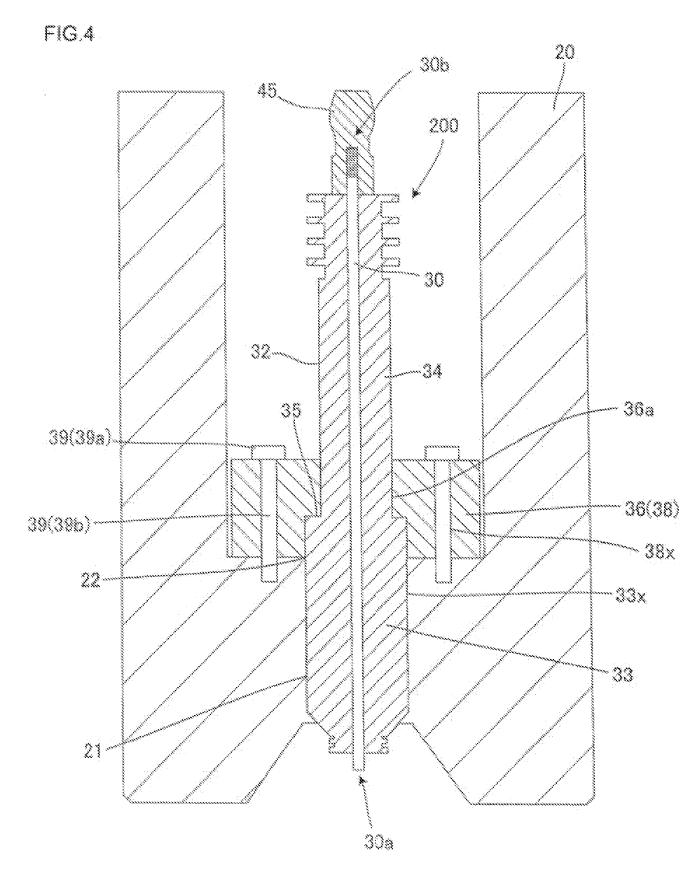

Moreover, as illustrated in FIG. 4, the insulator fixing means 36 may have a pressing member 38 and a fastening member 39. The pressing member 38 illustrated in FIG. 4 has an insulator through hole 36a larger than the outer diameter of the small-diameter portion 34 and smaller than the outer diameter of the large-diameter portion 33 of the insulator 32 and a fastening through hole 38x penetrating in a direction in parallel with the insertion direction of the insulator 32 formed. The fastening member 39 is inserted through the fastening through hole 38x of the pressing member 38 so as to fasten the pressing member 38 and the cylinder head 20 of the internal combustion engine. Here, FIG. 4 is a sectional view schematically illustrating a section in parallel with a direction in which the center electrode extends in a stable in which another embodiment of the ignition component of the present invention is attached to the internal combustion engine.

In an ignition component 200 illustrated in FIG. 4, the pressing member 38 is fixed by the fastening member 39 to the cylinder head 20 of the internal combustion engine. As a result, the stepped portion 35 of the insulator 32 is pressed by the pressing member 38, and the ignition component 200 is attached to the cylinder head 20 of the internal combustion engine. More reliable and firm fixation is made possible by employing the above configuration. Moreover, stress applied to the insulator 32 in attachment of the ignition component 200 is only the pressing force onto the stepped portion 35 of the insulator 32. Therefore, even if the insulator 32 is formed of an insulating material such as ceramic, for example, occurrence of a crack or chipping of the stepped portion 35 caused by the stress applied during attachment can be effectively suppressed.

As the fastening member 39, the bolt-shaped fastening member 39 having a head portion 39a and a screw portion 39b extended from the head portion 39a can be cited. The head portion 39a has a diameter larger, than the fastening through hole 38x of the pressing member 38. The screw portion 39b can be screwed into a screw hole formed in the peripheral edge of the opening portion 22 of the plug insertion hole 21 in the cylinder head 20 of the internal combustion engine.

(2) Ignition Component (Second Invention):

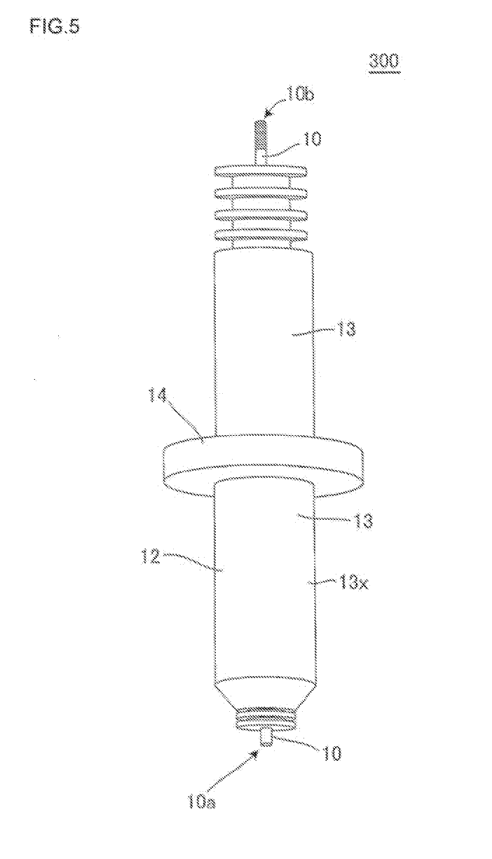

An ignition component 300 of an embodiment of an ignition component of the present invention (second invention) includes, as illustrated in FIGS. 5 to 7, a center electrode 10 and an insulator 12 disposed on an outer periphery of the center electrode 10. In the ignition component 300 of this embodiment, the insulator 12 has an columnar insulator main body 13 and a flange portion 14 in which a part of a side face 13x of the insulator main body 13 protrudes so that the outer diameter thereof becomes larger than the outer diameter of the insulator main body 13. The columnar insulator main body 13 is configured to be inserted into the plug insertion hole 21 of the cylinder head 20 of the internal combustion engine in a non-screwed state.

The ignition component 300 of this embodiment is attached to the cylinder head 20 of the internal combustion engine as follows. First, the insulator main body 13 of the insulator 12 is inserted into the opening portion 22 of the plug insertion hole 21 of the cylinder head 20 of the internal combustion engine so that the flange portion 14 of the insulator 12 is brought into contact with a peripheral edge of the opening portion 22 of the plug insertion hole 21. Then, the flange portion 14 in contact with the peripheral edge of the opening portion 22 of the plug insertion hole 21 and the cylinder head 20 of the internal combustion engine are fixed. As a result, the ignition component 300 is attached to the cylinder head 20 of the internal combustion engine. The ignition component 300 of this embodiment has the flange portion 14 protruding so that the outer diameter thereof is larger is formed on the columnar insulator main body 13 constituting the insulator instead of the stepped portion in the embodiment of the ignition component of the first invention described above. The stepped portion in the embodiment of the ignition component of the first invention is a stepped portion formed by the large-diameter portion and the small-diameter portion of the insulator.

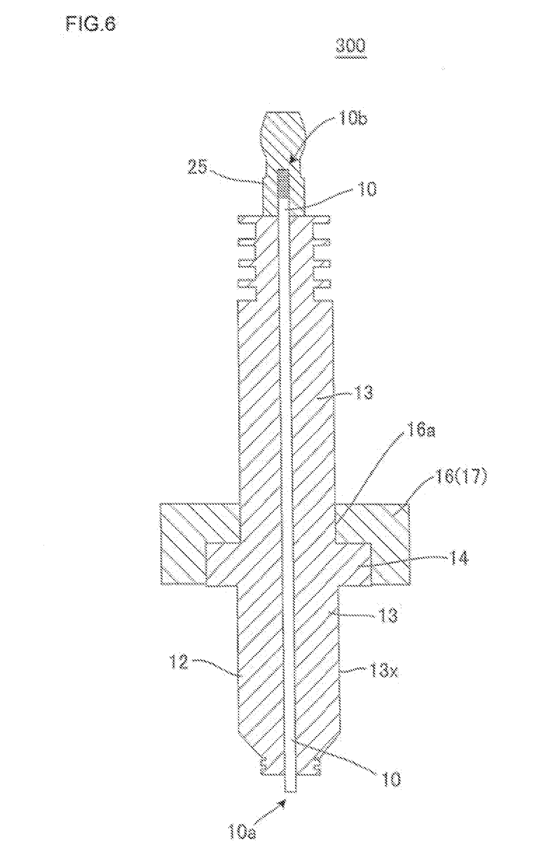

Here, FIG. 5 is a perspective view schematically illustrating an embodiment of an ignition component of the present invention (second invention). FIG. 6 is a sectional view schematically illustrating a section in parallel with a direction in which a center electrode extends in an embodiment of the ignition component of the present invention (second invention). FIG. 7 is a sectional view schematically illustrating a section in parallel with the direction in which the center electrode extends in a state in which the ignition component is attached to an internal combustion engine in an embodiment of the ignition component of the present invention (second invention). The cylinder head 20 of the internal combustion engine, the plug insertion hole 21, and an opening portion 22 of the plug insertion hole 21 are not constituent elements of the ignition component 300 of this embodiment. That is, the cylinder-head 20 of the internal combustion engine and the like are a part of an internal combustion engine using the ignition component 300 of this embodiment. FIG. 6 illustrates an example of the ignition component 300 further provided with insulator fixing means 16.

The ignition component 300 of this embodiment is not provided with a metal housing to be attached to the cylinder head of the internal combustion engine as in a prior-art ignition component. That is, the ignition component 300 of this embodiment is attached by directly inserting the insulator main body 13 into the opening portion 22 of the plug insertion hole 21 of the cylinder head 20 of the internal combustion engine.

Moreover, a screw portion such as a thread is not formed on a side face 13x of the insulator main body 13 of the ignition component 300 of this embodiment. Thus, the ignition component is not attached to the cylinder head by screwing of a screw portion on the metal housing as in the prior-art ignition component. That is, the ignition component 300 of this embodiment is attached to the cylinder head 20 of the internal combustion engine by inserting the insulator main body 13 of the insulator 12 into the opening portion 22 in the plug insertion hole 21 of the cylinder head 20 of the internal combustion engine in a non-screwed state. The phrase “inserted in the non-screwed state” refers to the state in which an article to be inserted (specifically, the “insulator main body”) is inserted in parallel with the insertion direction without rotation in screwed insertion performed by a screw or the like.

According to the ignition component 300 of this embodiment configured as above, insulation breakdown of the insulator 12 covering the center electrode 10 can be made difficult to occur. That is, in the ignition component 300 of this embodiment, a thickness of the insulator 12 can be increased by a portion corresponding to the thickness of the metal housing as compared with the prior-art ignition component. Thus, withstand voltage of the insulator 12 can be favorably improved without changing the size of the ignition component 300 itself, or in other words, the size of a space where the ignition component 300 is to be installed from the size of the prior-art ignition component. As a result, insulation breakdown of the insulator 12 can he made difficult to occur. As the size of a space where the ignition component 300 is installed, the inner diameter of the opening portion 22 of the plug insertion hole 21, for example, can be cited.

Moreover, as described above, since a screw portion such as a thread is not formed on the side face 13x of the insulator main body 13, electric field intensity between the insulator 12 (or more specifically, the “insulator main body 13”) and the plug insertion hole 21 is made uniform. Therefore, insulation breakdown of the insulator 12 can be made more difficult to occur. For example, in the ignition component having a screw portion formed on the side face (specifically, the side face of the insulator main body) of the insulator and screwed and inserted into the plug insertion hole of the cylinder head of the internal combustion engine, for example, suppression of occurrence of insulation breakdown is extremely difficult as follows. That is, in such an ignition component, when a high voltage is applied to the center electrode of the ignition component, a difference occurs in the electric field intensity between the peak portion and the trough portion of the thread of the screw portion, and even if the thickness of the insulator is increased, suppression of occurrence of insulation breakdown is extremely difficult.

Moreover, in the ignition component 300 of this embodiment, when the insulator main body 13 is inserted into the opening portion 22 of the plug insertion hole 21, the flange portion 14 of the insulator 12 is brought into contact with the peripheral edge of the opening portion 22 of the plug insertion hole 21. Thus, the insulator main body 13 is favorably inserted to an appropriate depth. That is, the outer diameter of the flange portion 14 is configured to be larger than the inner diameter of the opening portion 22 of the plug insertion hole 21. As described above, the flange portion 14 of the insulator 12 in the ignition component 300 of this embodiment also becomes a member for preventing falling into the plug insertion hole 21.

A fixing method between the ignition component 300 inserted into the plug insertion hole 21 and the cylinder head 20 of the internal combustion engine is not particularly limited. That is, the method may be any as long as the flange portion 14 in contact with the peripheral edge of the opening portion 22 of the plug insertion hole 21 and the cylinder head 20 of the internal combustion engine are fixed.

The ignition component 300 of this embodiment maybe further provided with the insulator fixing means 16 fixing the flange portion 14 in =tact with the peripheral edge of the opening portion 22 of the plug insertion hole 21 and the cylinder head 20 of the internal combustion engine. For example, an example of the ignition component 300 further provided with the above-described insulator fixing means 16 is illustrated in FIG. 7. The insulator fixing means 16 is a washer-shaped pressing member 17 in which an insulator through hole 16a is formed. This insulator fixing means 16 presses and supports the flange portion 14 in contact with the peripheral edge of the opening portion 22 of the plug insertion hole 21 onto the side of the cylinder head 20 of the internal combustion engine. As the pressing member 17, a fixing bracket. (fixing jig) and the like for pressing and supporting the surface on the side opposite to the surface of the flange portion 14 in contact with the peripheral edge of the opening portion 22 of the plug insertion hole 21 in the insertion direction of the ignition component 300 can be cited. According to such pressing member 17, the flange portion 14 and the cylinder head 20 of the internal combustion engine can be fixed above the opening portion 22 of the plug insertion hole 21. With such a fixing method, the outer shape or thickness of the insulator main body 13 is not restricted by the fixing method. Thus, high withstand voltage of the insulator 12 can be favorably maintained.

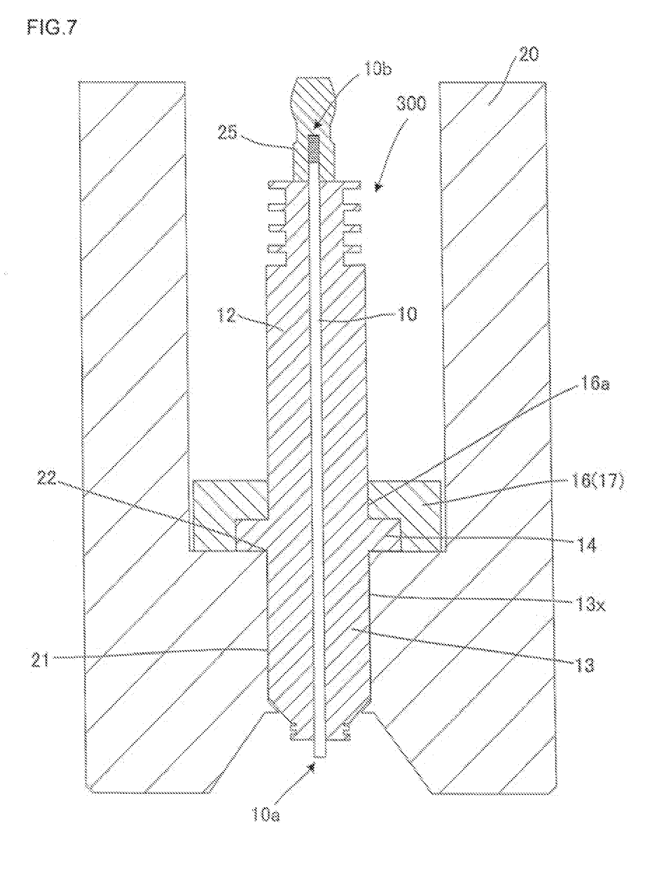

Moreover, as illustrated in FIG. 8, the insulator fixing means 15 may have a pressing member 18 and a fastening member 19. The pressing member 18 presses and supports the flange portion 14 in contact with the peripheral edge of the opening portion 22 of the plug insertion hole 21 onto the side of the cylinder head 20 of the internal combustion engine. In this pressing member 18, a fastening through hole 18x penetrating in a direction in parallel with the insertion direction of the insulator 12 is formed. The fastening member 19 is inserted through the fastening through hole 18x of the pressing member 18 and fastens the pressing member 18 and the cylinder head 20 of the internal combustion engine. Here, FIG. 8 is a sectional view schematically illustrating a section in parallel with a direction in which the center electrode extends in a state in which another embodiment of the ignition component of the present invention (second invention) is attached to an internal combustion engine.

In an ignition component 400 illustrated in FIG. 8, since the pressing member 18 is fixed to the cylinder head 20 of the internal combustion engine by the fastening member 19, the flange portion 14 supported by the pressing member 18 is fixed to the cylinder head 20 of the internal combustion engine. As a result, the ignition component 400 is attached to the cylinder head 20 of the internal combustion engine. More reliable and firm fixation is made possible by employing the above configuration. Moreover, stress applied to the insulator 12 in attachment of the ignition component 400 is only the pressing force from one of the surfaces of the flange portion 19 to the other surface of the flange portion 19. The one of the surfaces of the flange portion 14 refers to the surface on the side opposite to the surface in contact with the peripheral edge of the opening portion 22 of the plug insertion hole 21. The other surface of the flange portion 14 refers to the surface brought into contact with the peripheral edge of the opening portion 22 of the plug insertion hole 21. Therefore, even if the insulator 12 (or in other words, the insulator main body 13 and the flange portion 14) is formed of an insulating material such as ceramic, for example, occurrence of a crack or chipping of the flange portion 14 caused by the stress applied during attachment can be effectively suppressed. As the fastening member 19, the bolt-shaped fastening member 19 having a head portion 19a and a screw portion 195 extended from the head portion 19a can be cited. The head portion 19a has a diameter larger than the fastening through hole 18x of the pressing member 18. The screw portion 19b can be screwed into a screw hole formed in the peripheral edge of the opening portion 22 of the plug insertion hole 21 in the cylinder head 20 of the internal combustion engine.

(3) Configuration of Ignition Component:

Each constituent element of the ignition components of the first and second inventions will be described below in more detail.

(3-1) Center Electrode:

As illustrated in FIGS. 1 to 3, the center electrode 30 is a substantially rod-shaped electrode inserted into the insulator 32 so that an end portion of the center electrode 30 (hereinafter this end portion is referred to as a “tip portion 30a) protrudes from the tip of the insulator 32 on the internal combustion engine side. In the ignition component 100 illustrated in FIGS. 1 to 3, the end portion of the insulator 32 on the large-diameter portion 33 side is the tip on the internal combustion engine side. As the center electrode used in the ignition component of the second invention, the center electrode configured similarly to that used in the ignition component of the above-described first invention can be favorably used.

The other tip end portion of the center electrode 30 is arranged so that the end portion (hereinafter this end portion is referred to as a “edge portion 30b”) protrudes at the end portion on the side opposite to the end portion of the insulator 32 on the internal combustion engine side and is covered by an end terminal 45. The “end terminal” refers to a terminal to which a plug cord or a plug cap of a direct ignition or the like is connected. FIGS. 6 to 8 illustrate the end terminal with reference numeral 25.

The shape of the center electrode 30 is, as described above, preferably columnar penetrating from one of the end portions of the insulator 32 to the other end portion. Moreover, in order to fix the center electrode 30 in the insulator 32, a step may be provided at a part in the longitudinal direction (in other words, the insertion direction) of the center electrode 30.

If the center electrode 30 has a columnar shape, the outer diameter of the center electrode 30 is preferably 0.5 to 4.0 mm or more preferably 1.0 to 3.5 mm. By setting the outer diameter of the center. electrode 30 as above, discharging can be reinforced. For example, if the outer diameter of the center electrode 30 is less than 0.5 mm, the center electrode cannot be fixed easily and discharging might become weak. If the outer diameter of the center electrode 10 exceeds 4.0 mm, the thickness of the insulator might become relatively small.

The material of the center electrode 30 is not particularly limited. As the material of the center electrode 30, the same material as that of the center electrode of known ignition component of the prior-art can be cited as a preferable example. Specifically, as an internal material of the center electrode 30, copper or an alloy containing copper and the like can be cited, for example. As an external material of the center electrode 30, a Ni-based alloy and the like can be cited.

The shape of the tip portion 30a of the center electrode 30 is preferably a single or a plurality of needles. By configuring as above, discharging can be reinforced. This tip portion 30a preferably protrudes from the end portion of the insulator 32 at least by 1.0 mm.

The edge portion 30b of the center electrode 30 preferably protrudes from the end portion of the insulator 32 at least by 5 mm. The edge portion 30b is electrically connected to a power supply (not shown) for applying a voltage to the ignition component 100 by an electric wire or the like.

The prior-art ignition component has an opposite electrode (also referred to as a grounding electrode) for generating discharge from the center electrode. In the ignition components of this embodiment, its outer peripheral portion is formed of the insulator made of an insulating material. That is, the ignition components of this embodiment are not provided with a metal housing or the like on which the opposite electrode was arranged in the prior-art ignition component. Thus, if the opposite electrode is required, an electrode corresponding to the opposite electrode may be arranged in a combustion chamber of the cylinder head of the internal combustion engine.

(3-2) Insulator:

As illustrated in FIGS. 1 to 3, the insulator 32 has the center electrode 30 inserted and held and constitutes the outer peripheral portion in the ignition component 100. The insulator 32 is formed of a material having electric insulation.

The insulator 32 used in the ignition component in the embodiment of the first invention is formed of a columnar body with different diameters having the large-diameter portion 33 and the small-diameter portion 34 with the outer diameter smaller than this large-diameter portion 33. The large-diameter portion 33 becomes an insertion portion to be inserted into the plug insertion hole 21 of the cylinder head 20 of the internal combustion engine in a non-screwed state. The large-diameter portion 33 and the small diameter portion 34 constituting the insulator 32 are preferably formed by integrally forming the material having the above-described electric insulation (that is, the large-diameter portion 33 and the small-diameter portion 34 are integral). In this ignition component 100, the large-diameter portion 33 of the insulator 32 is inserted into the plug insertion hole 21 of the cylinder head 20 of the internal combustion engine, and the stepped portion 35 between the large-diameter portion 33 and the small-diameter portion 34 of the insulator 32 is pressed onto and fixed to the side of the cylinder head 20 of the internal combustion engine. As a result, the ignition component 100 is attached to the cylinder head 20 of the internal combustion engine. That is, the stepped portion 35 becomes a portion to which stress is applied in fixing the ignition component 100.

The large-diameter portion 33 of the insulator 32 is a columnar electric insulating member Which can be inserted into the plug insertion hole 21. The shape of the section perpendicular to the insertion direction of the large-diameter portion 33 can be determined as appropriate in accordance with the shape of the opening portion 22 of the plug insertion hole 21. The shape of the section perpendicular to the insertion direction of the large-diameter portion 33 is preferably a circle or a polygon. In the case of a polygon, it is further preferably a polygon of at least a hexagon or more.

The outer diameter of the large-diameter portion 33 can be determined as appropriate in accordance with the shape of the opening portion 22 of the plug insertion hole 21. If the shape of the section perpendicular to the insertion direction of the large-diameter portion 33 is a circle, the diameter (outer diameter) is preferably 10 to mm or particularly preferably 12 to 14 mm. By configuring as above, compatibility with the ignition component used in an engine in an existing automobile or the like can be obtained. That is, the ignition component of this embodiment can be used without large specification change (a shape change of the plug insertion hole or the like, for example) on the engine side to which the ignition component is to be attached. The large-diameter portion 33 preferably has a diameter of a certain size at least at a portion to be inserted into the plug insertion hole 21.

The length of the large-diameter portion 33 in the insertion direction (hereinafter also referred to simply as the “length of the large-diameter portion 33”) is not particularly limited, either. However, the length of the large-diameter portion 33 is preferably a length that can hold the insulator 32 in the following state when the insulator 32 is inserted into the plug insertion hole 21. That is, the position of the stepped portion 35 between the large-diameter portion 33 and the small-diameter portion 34 of the insulator 32 is at a position on the same surface as the cylinder head 20 of the internal combustion engine in which the plug insertion hole 21 is formed or a position close to it. By configuring as above, the ignition component 100 can be fixed easily.

The small-diameter portion 34 is a portion where the stepped portion 35 for fixing the insulator 32 to the cylinder head 20 of the internal combustion engine is formed and the shape or the like thereof is not particularly limited as long as the outer diameter thereof is formed smaller than the large-diameter portion 33.

The length of the insulator 32 in the insertion direction (hereinafter also referred to simply as the “length of the insulator”) is preferably a length that can be contained in a space where the ignition component 100 is installed. The “length of the insulator” refers to the length from the tip of the large-diameter portion 33 to the terminal end of the small-diameter portion 34 of the insulator 32. For example, the length of the insulator 32 is preferably 40 to 120 mm and more preferably 45 to 100 mm.

The thickness of the large-diameter portion 33 can be determined as appropriate in accordance with the shape of the opening portion 22 of the plug insertion hole 21. The thickness of the large-diameter portion 33 is, considering a clearance from the plug insertion hole 21, preferably a thickness that can be inserted into the opening portion 22 of the plug insertion hole 21 in a state in which the center electrode 10 is inserted therein. That is, supposing that an opening diameter of the opening portion 22 is R1 (mm), a diameter of the center electrode 10 is r1 (mm), and a clearance from the plug insertion hole 21 is a (mm), the thickness T (mm) of the large-diameter portion 33 preferably satisfies a relationship in the following formula (1). Since the large-diameter portion 33 itself is brought into close contact with the inner surface of the plug insertion hole 21 so as to seal a combustion pressure, the clearance a from the plug insertion hole 21 is preferably as small as possible. The clearance does not have to be provided as long as the large-diameter portion 33 can be inserted into the opening portion 22 of the plug insertion hole 21 without a gap. For example, it is preferable that the clearance a is within the range of 0≦a≦0.1. The thickness T (mm) of the large-diameter portion 33 is a thickness in a portion to be actually inserted into the plug insertion hole 21.

Thickness T={(R1−r1)/2}−a (1)

The thickness in the portion of the insulator to be inserted into the plug insertion hole (in other words, the thickness of the large-diameter portion) is preferably 2 mm or more.

As illustrated in FIGS. 5 to 7, the insulator 12 used in the ignition component 300 of the embodiment of the second invention has the columnar insulator main body 13 and the flange portion 14 in which a part of the side face 13x of the insulator main body 13 protrudes so that the outer diameter thereof becomes larger than the outer diameter of the insulator main body 13. The columnar insulator main body 13 is inserted into the plug insertion hole 21 of the cylinder head 20 of the internal combustion engine in a non-screwed state. The insulator main body 13 and the flange portion 14 constituting the insulator 12 are preferably formed by integrally forming the material having the above-described electric insulation. That is, the insulator main body 13 and the flange portion 14 are separate constituent elements but may be formed as a single electric insulating member. It is needless to say that the insulator 12 may be formed by disposing the flange portion 14 whose outer diameter is larger than the outer diameter of the insulator main body 13 on a part of the side face of the insulator main body 13.

The insulator main body 13 is a columnar electric insulating member that can be inserted into the plug insertion hole 21. The tip side from the portion where the flange portion 19 is formed in the insulator main body 13 is a portion to be inserted into the plug insertion hole 21. The shape of the section perpendicular to the insertion direction of the insulator main body 13 can be determined as appropriate in accordance with the shape of the opening portion 22 of the plug insertion hole 21. The shape of the section perpendicular to The insertion direction of the insulator main body 13 is preferably a circle or a polygon.

In the case of a polygon, it is further preferably a polygon of at least a hexagon or more.

The outer diameter of the insulator, main body 13 can be determined as appropriate in accordance with the shape of the opening portion 22 of the plug insertion hole 21. If the shape of the section perpendicular to the insertion direction of the insulator main body 13 is a circle, the diameter (outer diameter) is preferably 14 to 14 mm or more preferably 12 to 14 mm. By configuring as above, compatibility with the ignition component used in an engine in an existing automobile or the like can be obtained. That is, the ignition component of this embodiment can be used without large specification change (a shape change of the plug insertion hole or the like, for example) on the engine side to which the ignition component is to be attached. The insulator main body 13 preferably has a diameter of a certain size at least at a portion to be inserted into the plug insertion hole 21.

The length of the insulator main body 13 in the insertion direction (hereinafter also referred to simply as the “length of insulator main body 13”) is not particularly limited, either. However, the length of the insulator main body 13 is preferably a length such that the length from the portion where the flange portion 14 is formed in the insulator main body 13 to the tip side can penetrate at least the plug insertion hole 21. Moreover, the edge side from the portion where the flange portion 14 of the insulator main body 13 is formed preferably has the length that is contained in a space where the ignition component 300 is to be installed. The “length of the insulator main body 13” refers to the length from the tip of the insulator main body 13 (that is, the end portion where the tip portion 10a of the center electrode 10 is exposed) to the edge of the insulator main body 13 (that is, the end portion where the edge portion 10b of the center electrode 10 is exposed). For example, the length of the insulator main body 13 is preferably 40 to 120 mm or more preferably 45 to 100 mm.

The thickness of the insulator main body 13 can be also determined as appropriate in accordance with the shape of the opening portion 22 of the plug insertion hole 21. The thickness of the insulator main body 13 is preferably a thickness similar to the thickness of the large-diameter portion in the ignition component of the embodiment of the first invention. For example, the thickness in the portion of the insulator to be inserted into the plug insertion hole is 2 mm or more.

Moreover, as a measure for preventing compression leakage from the internal combustion engine, the flange portion may be formed as follows. The length of the flange portion in the direction to be inserted into the plug insertion hole may gradually decrease from the root portion of the flange portion to the outermost peripheral portion and the portion from the root portion of the flange portion to the outermost peripheral portion may be formed having a tapered shape with respect to the surface perpendicular to the direction to be inserted into the plug insertion hole. As described above, by forming the surface of the flange portion on the internal combustion engine side in the tapered shape, the compression leakage from the internal combustion engine can be effectively prevented.

Moreover, the insulator which is the ignition component of the embodiments of the first and second inventions may have a tapered sealed portion formed at the tip portion thereof. By forming such sealed portion, the compression leakage from the internal combustion engine can be effectively prevented.

Moreover, the insulator which is the ignition component of the embodiments of the first and second inventions preferably has corrugation formed on at least either of the tip portion and the edge portion. By forming such corrugation, a creepage distance of the insulator can be increased. That is, by means of the corrugation, the surface distance of the insulator in the insertion direction is increased, and a creepage discharge voltage between the anode and the cathode can be raised, for example.

Both in the ignition component 100 illustrated in FIGS. 1 to 3 and the ignition component 300 illustrated in FIGS. 5 to 7, the corrugation is formed on the edge portion of the insulator (in the vicinity of a power cable connection portion) so as to increase the creepage distance. A voltage much higher voltage than the voltage used in the prior-art ignition component can be applied to the ignition component of the embodiments of the first and second inventions. Thus, the portion where the above-described corrugation is preferably covered by a material with a low relative permittivity such as a commercially available silicon resin or the like so as to further reinforce insulation of the portion where the corrugation is formed.

The reason why the insulation thereof is reinforced by covering the portion where the corrugation is formed by a material with low relative permittivity can be as follows. Ease of creepage discharge is in proportion with the intensity of the relative permittivity of the material constituting the member. For example, if the insulator is formed of alumina, the relative permittivity is approximately 10. On the other hand, in the case of the silicon resin, the relative permittivity is approximately 3. Therefore, by covering the portion where the corrugation is formed with the material with low relative permittivity such as a silicon resin, insulation can be reinforced. The material with low relative permittivity is not limited to the silicon resin, but a fluorine resin (the relative permittivity is approximately 2) or an epoxy resin (the relative permittivity is approximately 3), for example, can be used if the material has a low relative permittivity and a desired heat resistance. It is only necessary that the heat resistance of the covering material complies with the environment in which the ignition component is used. For example, if the ignition component is used in an engine, it is only necessary that the covering material has heat resistance of around 200° C. As another Method of increasing the creepage distance, the length of the insulator can be prolonged. However, in that time, the strength of the insulator might be lowered due to the prolongation of the insulator or formation of a through hole into which the center electrode is to be inserted might become difficult.

As illustrated in FIGS. 5 to 7, the flange portion 14 of the insulator 12 is the portion in which the outer diameter of the insulator main body 13 protrudes in a part of the side face of the insulator main body 13 so as to become larger than the other portions. The insulator main body 13 and the flange portion 14 are separate constituent elements but may be formed as a single electric insulating member or the flange portion 14 whose outer diameter is larger than the outer diameter of the insulator main body 13 may be disposed on the side face of the columnar insulator main body 13. From the viewpoint of the intensity of the insulator 12, the insulator main body 13 and the flange portion 14 are preferably formed as a single electric insulating member.

When the insulator 12 (or in other words, the ignition component 300) is inserted to a predetermined depth of the plug insertion hole 21, the flange portion 14 also becomes a portion for preventing subsequent falling thereof. From this fact, the outer diameter of the flange portion 14 is preferably larger than the outer diameter of the insulator main body 13 and also larger than the opening diameter of the opening portion 22 of the plug insertion hole 21 by 5 to 20 mm or more preferably by 10 to 15 mm. For example, if the outer diameter of the flange portion 14 is too small, the flange portion 14 is not favorably locked by the periphery of the opening portion 22 of the plug insertion hole 21 and holding of the insulator 12 might become difficult. On the other hand, if the outer diameter of the flange portion 14 is too large, a space for installing the ignition component is required more than necessary.

The length of the flange portion 14 in the insertion direction of the ignition component 300 (hereinafter also referred to as the “thickness of the flange portion 14”) is not particularly limited, either. The thickness of the flange portion 14 is preferably at least 3 mm or more, or more preferably 4 mm or more, or particularly preferably 5 mm or more from the viewpoint of mechanical strength of the flange portion 14. Moreover, from the viewpoint of size reduction of the ignition component 300, the thickness of the flange portion 14 may be 3 to 8 mm or moreover 4 to 6 mm.

The position where the flange portion 14 is formed is preferably within the range of 30 to 60% of the length in the insertion direction from the tip side of the insulator main body 13. By configuring as above, the portion to be inserted into the plug insertion hole 21 can be favorably ensured, while the edge side portion protruding from the cylinder head 20 of the internal combustion engine can be contained in the installation space in a compact manner.

The material of the insulator is not particularly limited as long as it has electric insulation. For example, an alumina-based sintered material or the like can be cited.

(3-3) Insulator fixing means

The ignition component of this embodiment may be further provided with insulator fixing means for fixing the insulator to the cylinder head of the internal combustion engine. The insulator fixing means is a fixing jig for fixing the insulator. Fixing means for realizing appropriate fixation can be selected as appropriate in accordance with the configuration of the insulator in the embodiments of the first and second inventions (ignition component).

In FIG. 3, an example in which the insulating fixing means 36 for pressing the stepped portion 35 of the insulator 32 onto the side of the cylinder head 20 of the internal combustion engine is further provided is illustrated. The insulator fixing means 36 is formed of the washer-shaped pressing member 37 in which the insulator through hole 36a larger than the outer diameter of the small-diameter portion 34 and smaller than the outer diameter of the large-diameter portion 33 of the insulator 32 is formed.

Moreover, in FIG. 7, an example in which the insulator fixing means 16 for fixing the flange portion 14 of the insulator 12 and the cylinder head 20 of the internal combustion engine is further provided is illustrated. The insulator fixing means 16 is formed of the pressing member 17 for pressing and supporting the flange portion 14 in contact with the peripheral edge of the opening portion 22 of the plug insertion hole 21 onto the side of the cylinder head 20 of the internal combustion engine.

Moreover, as illustrated in FIG. 4, as the pressing member 38 constituting the insulator fixing means 36, the fastening through hole 38x into which the fastening member 39 for fastening this pressing member 38 and the cylinder head 20 of the internal combustion engine is inserted may be further formed. The fastening member 39 is inserted into the fastening through hole 38x of the pressing member 38, and the pressing member 38 and the cylinder head 20 of the internal combustion engine are fixed by fastening.

Moreover, as illustrated in FIG. 8, there may be the pressing member 18 for pressing and supporting the flange portion 14 in contact with the peripheral edge of the opening portion 22 of the plug insertion hole 21 onto the side of the cylinder head 20 of the internal combustion engine, and the pressing member 18 may further have the fastening through hole 18x penetrating in a direction in parallel with the insertion direction of the insulator 12 formed. In such pressing member 18, too, the fastening member 19 is inserted into the through hole 18x of the pressing member 18, and the pressing member 18 and the cylinder head 20 of the internal combustion engine are fixed by fastening.

As the material of the pressing member, an iron material, stainless steel, an aluminum alloy and the like can be cited. Moreover, as the fastening member, as illustrated in FIGS. 4 and 8, the bolt-shaped fastening member 19 having the head portion 19a and the screw portion 19b can be cited.

The insulator fixing means used in the ignition component of this embodiment is not limited to the fixing jig such as the above-described pressing member. That is, the insulator fixing means can be of any type as long as it can fix the insulator and the cylinder head of the internal combustion engine. The insulator fixing means preferably does not cause breakage such as a crack, chipping and the like in the stepped portion between the large-diameter portion and the small-diameter portion of the insulator or the flange portion of the insulator when the insulator is fixed. Thus, the insulator fixing means using a fixing method of pressing and supporting a part of the insulator (the stepped portion or the flange portion, for example) is more preferable. For example, a fixing method in which a compression stress is applied in the thickness direction of the flange portion is better than a fixing method in which a shearing stress is applied to the root portion of the flange portion in which a part of the side face of the insulator main body protrudes in fixing.

(4) Manufacturing Method of Ignition Component:

Subsequently, a manufacturing method of the ignition component of this embodiment will be described by using a method of manufacturing the ignition component 300 illustrated in FIGS. 5 to 7 as an example.

First, by using a ceramic material such as alumina, a formed body having a columnar formed body (a formed body to be an insulator main body later) and a flange portion in which a part of the side face of this formed body protrudes so that the outer diameter thereof is larger than the outer diameter of the formed body is fabricated by various press forming methods. In the columnar formed body, a through hole penetrating in the center axis direction is formed. The center electrode of the ignition component is disposed in the through hole of this formed body.

Subsequently, this formed body is sintered so as to obtain an insulator having a columnar insulator main body to be inserted into the plum insertion hole of the cylinder head of the internal combustion engine in a non-screwed state and a flange portion in which a part of the side face of the insulator main body protrudes so that the outer diameter thereof is larger than the outer diameter of the insulator main body. The insulator of the ignition component 100 illustrated in FIGS. 1 to 3 can be also formed by the similar method.

Separately from the fabrication of the insulator, a center electrode of the ignition component is fabricated. As a fabrication method of the center electrode, a method of fabricating an inner material portion and an external material portion of the center electrode by forming a conductive material for forming the center electrode into predetermined shapes and then, by combining them and applying extrusion forming to them so as to fabricate a complex electrode (center electrode) can be cited. As a conductive material for forming the center electrode, the same material as that of the center electrode of the prior-art known ignition component can be used, and a heat resistant nickel alloy and copper or a heat resistant nickel alloy and a copper alloy and the like can be cited. Moreover, as the conductive material, a nickel alloy, noble metal, conductive ceramic and the like can be also used.

Subsequently, the ignition component of this embodiment can be manufactured by disposing the center electrode in the through hole penetrating from one of the end portions to the other end portion of the obtained insulator.

### EXAMPLE

The present invention will be described below in more detail by examples but the present invention is not limited by the examples at all.

### Example 1

First, a ceramic material for fabricating the insulator was prepared. As the ceramic material, alumina was used.

Subsequently, using the obtained ceramic material, a formed body having a columnar formed body and a flange portion in which a part of the side face of this formed body protrudes so that the outer diameter thereof is larger than the outer diameter of the formed body was fabricated by various press forming methods. Moreover, a through hole penetrating in the center axis direction thereof was formed in the columnar formed body. Subsequently, the obtained formed body was sintered at 1500° C. for 5 hours so as to fabricate an insulator having a columnar insulator main body and a flange portion in which a part of the side face of the insulator main body protrudes so that the outer diameter thereof is larger than the outer diameter of the insulator main body was fabricated.

The length of the insulator main body of the insulator in the insertion direction was 90 mm, and the outer diameter of the insulator main body was 13 mm. The insulator main body did not have a joint portion by screwing of a screw portion or the like at the spot inserted into the plug insertion hole of the cylinder head of the internal combustion engine, and the outer diameter thereof was formed having a uniform columnar shape within the range of 30 mm to be inserted into the plug insertion hole. The thickness of the insulator main body within the range to be inserted into the plug insertion hole was 5 mm.

Moreover, the flange portion of the insulator was formed at the position at 30 mm from the tip side of the insulator main body. The outer diameter of the flange portion was 17 mm and the length (thickness) in the insertion direction of the flange portion was 5 mm.

Separately from the above insulator, the inner material portion and the external material portion of the center electrode were fabricated by forming a heat resistant nickel alloy and copper into predetermined shapes. After that, the obtained inner material portion and external material portion were combined and subjected to extrusion forming so as to form a complex electrode. The obtained complex electrode was made a center electrode of the ignition component of Example 1. The outer diameter of the center electrode was 3 mm and the length was 97 mm.

The obtained center electrode was disposed into the through hole in the insulator main body of the insulator so as to fabricate the ignition component of Example 1.

The ignition component of Example 1 was evaluated by the following methods for “breakage evaluation by insulation breakdown” and “electric field intensity evaluation”.

[Breakage Evaluation by Insulation Breakdown]

The insulator main body of the ignition component was inserted into the plug insertion hole of the cylinder head of the internal combustion engine, and the ignition component was attached to the cylinder head of the internal combustion engine. The opening diameter of the plug insertion hole was 13 mm. In the ignition component of Example 1, the insulator main body of the ignition component was inserted into the plug insertion hole. of the cylinder head of the internal combustion engine in a non-screwed state. After that, a voltage of 20 kV to 50 kV is applied to the center electrode of the ignition component, and electric discharge was caused at the tip portion of the center electrode of the ignition component. After that, the ignition component of Example 1 was removed from the cylinder head of the internal combustion engine, and the breakage state of the insulator main body was visually checked (breakage evaluation by insulation breakdown).

[Electric Field Intensity Evaluation]

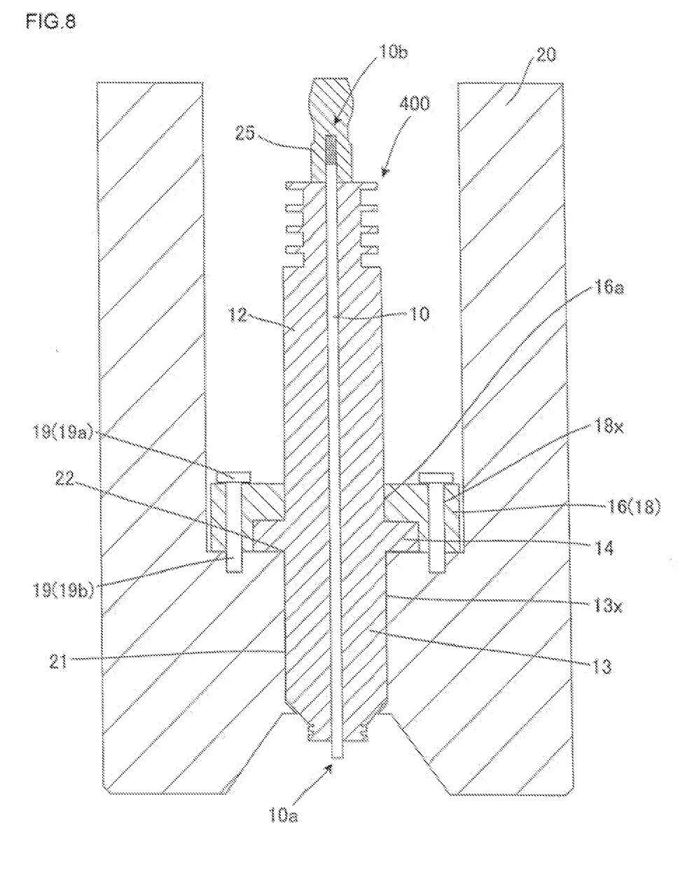

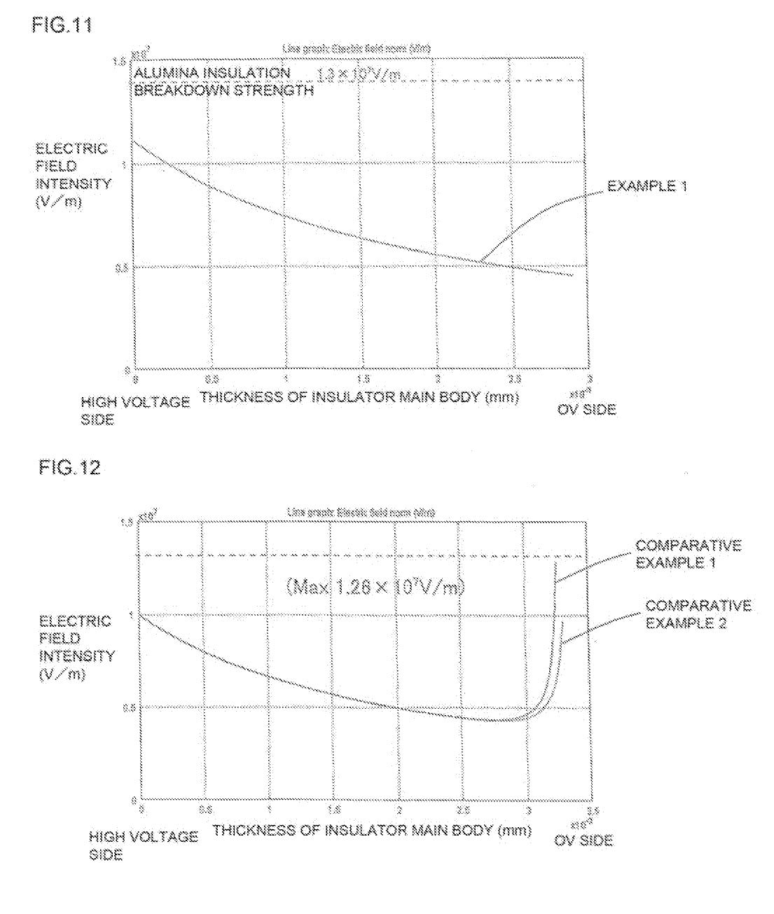

The electric field intensity between the ignition component and the cylinder head of the internal combustion engine was evaluated when the ignition component of Example 1 was inserted into the plug insertion hole of the cylinder head of the internal combustion engine in a non-screwed state, and a voltage of 5 kV to 40 kV was applied. The opening diameter of the plug insertion hole was set to 14 mm. As an evaluation method, a 2D axisymmetric model in the same state as the ignition component of Example 1 inserted into the plug insertion hole of the cylinder head 25′ of the internal combustion engine was fabricated, and a static electric field of this 2D axisymmetric model was calculated. The 2D axisymmetric model was, as illustrated in FIG. 9, a model in which the center electrode 10 (high voltage side) and the cylinder head 20 of the internal combustion engine (OV side) are oppositely arranged sandwiching the insulator main body 13 having the thickness of 2.9 mm with respect to a symmetric axis L of the 2D axisymmetric model. Here, FIG. 9 is a schematic diagram illustrating the 2D axisymmetric model used in calculation of the static electric field of the ignition component of Example 1. In FIG. 9, a figure of one side of the symmetric axis L of the 2D axisymmetric model is shown. In calculation of the static electric field, the electric field intensity at the center part in the direction of the axis L of the insulator main body 13 was acquired. The obtained result is shown in FIG. 11. FIG. 11 is a graph illustrating the result of calculation of the static electric field of the ignition component of Example 1, in which the lateral axis indicates the “thickness of the insulator main body (mm)” and the vertical axis indicates the “electric field intensity (V/m)”.

### Comparative Example 1

The insulator in which a screw portion is formed on the side face of the insulator main boy was fabricated by using the ceramic material prepared similarly to the ceramic material used in fabrication of the insulator of Example 1. The insulator fabricated in Comparative Example 1 had the shape similar to that of Example 1 except that the shape of the insulator was made as follows and a screw portion was formed on the side face of the insulator main body as follows.

The insulator of Comparative Example 1 has the length of the insulator main body in the insertion direction of 90 mm and the outer diameter of the insulator main body of 13 mm. Moreover, in this insulator, a screw portion was formed on the side face of the insulator main body within the range of 30 mm to be inserted into the plug insertion hole. The screw portion had the height of the thread at 0.7 mm, the pitch of the thread at 0.7 mm, the angle of the thread at 60°, and an apex R of the top portion of the thread at 50 μm. The thickness of the insulator main body was 3.9 mm at the top portion of the thread and 3.2 mm at the trough portion of the thread.

The ignition component of Comparative Example 1 was fabricated by disposing the center electrode fabricated by a method similar to that of the center electrode of Example 1 in the obtained insulator. The ignition component of Comparative Example 1 was evaluated by the methods similar to those of Example 1 for the “breakage evaluation by insulation breakdown”. In the “breakage evaluation by insulation breakdown” in Comparative Example 1, as a cylinder head of an internal combustion engine to which the ignition component is to be attached, a cylinder head in which a screw portion screwed with the screw portion in the insulator main body is formed on the inner surface of the plug insertion hole was used.

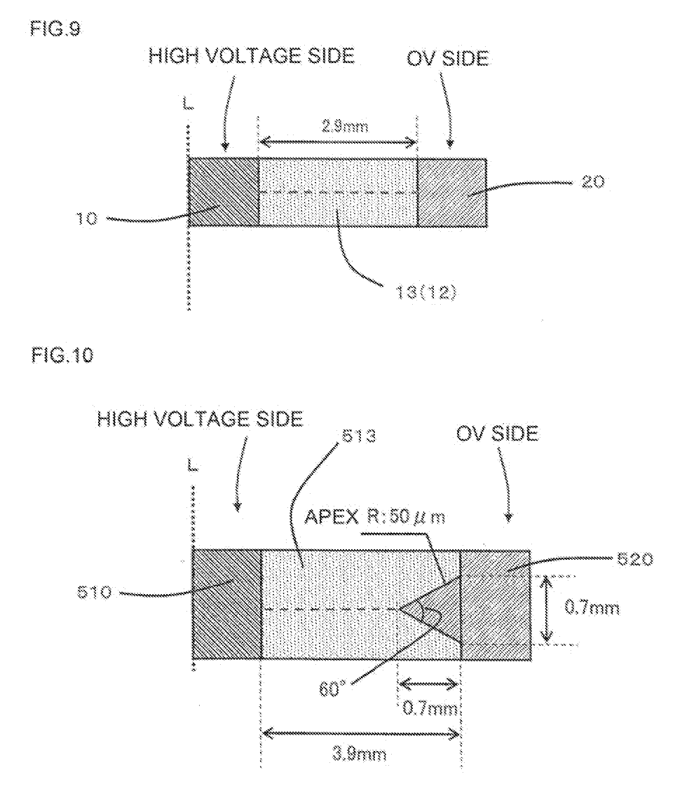

The “electric field intensity evaluation” was conducted for the ignition component of Comparative Example 1. First, a 2D axisymmetric model of the ignition component of Comparative Example 1 was fabricated, and the static electric field of this 2D axisymmetric model was calculated. The 2D axisymmetric model is, as illustrated in FIG. 10, a model in which a center electrode 510 (high voltage side) and a cylinder head 520 of the internal combustion engine (OV side) are oppositely arranged sandwiching the insulator main body 513 on which the above-described screw portion is formed with respect to the symmetric axis L of the 2D axisymmetric model. Here, FIG. 10 is a schematic diagram illustrating the 2D axisymmetric model used in calculation of the static electric field of the ignition component of Comparative Example 1. In FIG. 10, a figure of one side of the symmetric axis L of the 2D axisymmetric model is shown. In calculation of the static electric field, the electric field intensity at the center part in the direction of the axis L of the insulator main body 513 was acquired. The obtained result is shown in FIG. 12. FIG. 12 is a graph illustrating the result of calculation of the static electric field of the ignition component of Comparative Examples 1 and 2, in which the lateral axis indicates the “thickness of the insulator main body (mm)” and the vertical axis indicates the “electric field intensity (V/m)”.

### Comparative Example 2

An ignition component was fabricated in a method similar to that of Comparative Example 1 except that the apex R of the top portion of the thread of the screw portion formed on the side face of the insulator main body was set to 100 μm. The obtained ignition component was evaluated by the method similar to that of Comparative Example 1 for the “breakage evaluation by insulation breakdown” and the “electric field intensity evaluation”. The result of the electric field intensity evaluation is illustrated in FIG. 12.

(Results)

In the ignition components of Comparative Examples 1 and 2 on which the screw portion was formed on the insulator main body, breakage occurred in the trough portion of the screw portion when a high voltage was applied to the center electrode. Specifically, a mark (an arc mark) indicating the flow of an arc current was confirmed on the trough portion of the screw portion. Moreover, as illustrated in FIGS. 11 and 12, the ignition components of Comparative Examples 1 and 2 had the electric field intensity approximately twice of that in the ignition component of Example 1. The electric field intensity is considered to have been increased since the trough portion of the screw portion was formed with a sharp angle and the electric field was concentrated if the screw portion was formed on the insulator main body.

### INDUSTRIAL APPLICABILITY

The ignition component of the present invention can be used as an igniting device for an internal combustion engine.

### REFERENCE SIGNS LIST

10 center electrode

10a tip portion (tip portion of center electrode)

10b edge portion (edge portion of center electrode)

12 insulator

13 insulator main body

13x side face

14 flange portion

16 insulator fixing means

16a insulator through hole

17, 18 pressing member

18x fastening through hole (fastening through hole of pressing member)

19 fastening member

19a head portion

19b screw portion

20 cylinder head of internal combustion engine

21 plug insertion hole

22 opening portion (opening portion of plug insertion hole)

25 end terminal

30 center electrode

30a tip portion (tip portion of center electrode)

30b edge portion (edge portion of center electrode)

32 insulator

33 large-diameter portion

33x side face

34 small-diameter portion

35 stepped portion (stepped portion between large-diameter portion and small-diameter portion)

36 insulator fixing means

36a insulator through hole

37, 38 pressing member

38x fastening through hole (fastening through hole of pressing member)

39 fastening member

39a head portion

39b screw portion

45 end terminal

100, 200, 300, 400 ignition component

510 center electrode

513 insulator main body

520 cylinder head of internal combustion engine

L symmetric axis

What is claimed is:

1. An ignition component comprising:
a center electrode and an insulator disposed on an outer periphery of said center electrode, wherein
said insulator is formed of a columnar body with different diameters having a large-diameter portion which becomes an insertion portion to be inserted into a plug insertion hole of a cylinder head of an internal combustion engine in a non-screwed state and a small-diameter portion having an outer diameter smaller than that of said large-diameter portion; and
said ignition component is attached to said cylinder head of the internal combustion engine when said large-diameter portion of said insulator is inserted into said plug insertion hole of said cylinder head of the internal combustion engine and a stepped portion between said large-diameter portion and said small-diameter portion of said insulator is pressed onto and fixed to the side of said cylinder head of the internal combustion engine.

2. The ignition component according to claim 1, further comprising:
insulator fixing means for pressing said stepped portion of said insulator onto the side of said cylinder head of the internal combustion engine.

3. The ignition component according to claim 2, wherein
said insulator fixing means is a washer-shaped pressing member in which an insulator through hole larger than an outer diameter of said small-diameter portion and smaller than an outer diameter of said large-diameter portion is formed.

4. An ignition component comprising:
a center electrode and an insulator disposed on an outer periphery of said center electrode, wherein
said insulator has a columnar insulator main body inserted into a plug insertion hole of a cylinder head of an internal combustion engine in a non-screwed state and a flange portion in which a part of a side face of said insulator main body protrudes so that an outer diameter thereof becomes larger than an outer diameter of said insulator main body; and
said ignition component is attached to said cylinder head of the internal combustion engine when said insulator main body of said insulator is inserted into an opening portion of said plug insertion hole of said cylinder head of the internal combustion engine so that said flange portion of said insulator is brought into contact with a peripheral edge of the opening portion of said plug insertion hole and said flange portion in contact with the peripheral edge of the opening portion of said plug insertion hole and said cylinder head of the internal combustion engine are fixed.

5. The ignition component according to claim 4, wherein
a length of said flange portion in a direction to be inserted into said plug insertion hole is 5 mm or more.

6. The ignition component according to claim 4, wherein
the length of said flange portion in the direction to be inserted into said plug insertion hole gradually decreases from a root portion to the outermost periphery portion of said flange portion, and a portion from the root portion to the outermost periphery portion of said flange portion is formed in a tapered shape with respect to a surface perpendicular to the direction inserted into said plug insertion hole.

7. The ignition component according to claim 5, wherein
the length of said flange portion in the direction to be inserted into said plug insertion hole gradually decreases from a root portion to the outermost periphery portion of said flange portion, and a portion from the root portion to the outermost periphery portion of said flange portion is formed in a tapered shape with respect to a surface perpendicular to the direction inserted into said plug insertion hole.

8. The ignition component according to claim 4, further comprising:
insulator fixing means for fixing said flange portion in contact with a peripheral edge of the opening portion of said plug insertion hole and said cylinder head of the internal combustion engine.

9. The ignition component according to claim 7, further comprising:
insulator fixing means for fixing said flange portion in contact with a peripheral edge of the opening portion of said plug insertion hole and said cylinder head of the internal combustion engine.

10. The ignition component according to claim 9, wherein
said insulator fixing means is a pressing member for pressing and supporting said flange portion in contact with the peripheral edge of the opening portion of said plug insertion hole onto the side of said cylinder head of the internal combustion engine.

11. The ignition component according to claim 3, wherein
in said pressing member, a fastening through hole into which a fastening member for fastening said pressing member and said cylinder head for the internal. combustion engine is inserted is further formed, said fastening member being inserted through said fastening through hole of said pressing member, and said pressing member and said cylinder head of the internal combustion engine being fixed by fastening.

12. The ignition component according to claim 10, wherein
in said pressing member, a fastening through hole into which a fastening member for fastening said pressing member and said cylinder head for the internal combustion engine is inserted is further formed, said fastening member being inserted through said fastening through hole of said pressing member, and said pressing member and said cylinder head of the internal combustion engine being fixed by fastening.

13. The ignition component according to claim 12, wherein
said fastening member has a head portion having a diameter larger than said through hole and a screw portion extended from said head portion and capable of being screwed into a screw hole formed on a peripheral edge of the opening portion of said plug insertion hole of said cylinder head of the internal combustion engine.

14. The ignition component according to claim 1, wherein
a thickness of a portion of said insulator to be inserted into said plug insertion hole is 2 mm or more.

15. The ignition component according to claim 13, wherein
a thickness of a portion of said insulator to be inserted into said plug insertion hole is 2 mm or more.

16. The ignition component according to claim 1, wherein
a tapered sealed portion is formed at a tip portion of said insulator to be inserted into said plug insertion hole.

17. The ignition component according to claim 15, wherein
a tapered sealed portion is formed at a tip portion of said insulator to be inserted into said plug insertion hole.
